(19) United States
(12) Patent Application Publication
(10) Pub. No.: US 2005/0168018 A1
(43) Pub. Date: Aug. 4, 2005

(54) Pneumatic seating system for use with a motorcycle

(76) Inventor: George Paul Cox, Brooklyn, NY (US)

Correspondence Address: MCCORMICK, PAULDING & HUBER LLP, CITY PLACE II, 185 ASYLUM STREET, HARTFORD, CT, 06103, US

(21) Appl. No.: 11/049,317

(22) Filed: Feb. 2, 2005

Related U.S. Application Data
(60) Provisional application No. 60/541,316, filed on Feb. 3, 2004.

(51) Int. Cl. B62J 1/26

(52) U.S. Cl. 297/200

(57) ABSTRACT

An pneumatic seating system for use with a motorcycle including a mount for pivotally mounting a motorcycle seat to the frame of a motorcycle. The system includes an air spring mountable between an end portion of the motorcycle seat and the frame. The air spring being adjustable between inflated and deflated positions, the inflated position wherein pressurized air is retained in the cavity such that a length of the air spring is extended so that the seat is spaced from the frame, the deflated position wherein the air spring is in a retracted position. An air compressor is provided for inflating the air spring. An air release valve is coupled to the opening of the air spring for releasing pressurized air from the air spring. The system providing adjustable cushioning between the seat and the frame of the motorcycle for improving the comfort of a rider on the motorcycle.

### CROSS REFERENCE TO RELATED APPLICATIONS

This application is related to an earlier filed Provisional Application Ser. No. 60/541,316 filed Feb. 3, 2004 entitled “Adjustable Pneumatic Seating System” which is incorporated by reference herein.

### FIELD OF THE INVENTION

The present invention generally relates to a pneumatic seating system, and more particularly, to a pneumatic seating system for use with a rigid frame motorcycle.

### BACKGROUND OF THE INVENTION

In general, a rigid frame motorcycle has no rear suspension system. Often, custom made motorcycles have chassis without a rear suspension system and include a rear wheel mounted directly to a steel frame of the motorcycle. Usually, rigid frame motorcycles have a seat attached directly to the frame of the motorcycle which provides little or no cushioning for the rider of the vehicle sitting on the seat. Because of the lack of a rear suspension system, most rigid frame motorcycles are uncomfortable to ride especially for long periods of time.

In the past, motorcycle seats have been designed with coil springs attached to a base thereof for providing some cushioning between the seat and the frame of the motorcycle. However, these type of seats normally include exposed springs and hardware which detracts from the shape and appearance of the motorcycle and are therefore not suitable for use with the sleeker or lean styling of many currently designed rigid frame motorcycles. Further the coil spring seats are not adjustable for different riders or road conditions.

Based on the foregoing, it is the general object of the present invention to provide a pneumatic seating system for use with motorcycles that improves upon, or overcomes the problems and drawbacks associated with prior art motorcycle seats.

### SUMMARY OF THE INVENTION

The present invention provides a pneumatic seating system for use with a motorcycle. The system includes means for pivotally mounting a first end portion of a motorcycle seat to the frame of a motorcycle. Also included is an air spring mountable between a second end portion of the motorcycle seat and the frame, the air spring having a flexible housing defining a cavity for retaining pressurized air. The air spring further defining an opening in fluid communication with the cavity for receiving and expelling pressurized air from the cavity.

The air spring being adjustable between inflated and deflated positions, the inflated position being wherein pressurized air is retained in the cavity such that a length of the air spring is extended so that the second end portion of the seat is spaced from the frame. The deflated position being wherein the air spring is in a retracted position such that the second end portion of the seat is substantially adjacent and supported by the frame.

The system also includes an air compressor mounted to the frame and having an outlet coupled to the opening of the air spring for pressurizing the air spring. An air release valve is also coupled to the opening of the air spring for releasing pressurized air from the air spring. The air spring providing adjustable cushioning between the seat and the frame of the motorcycle for improving the comfort of a rider on the motorcycle.

Preferably, the air compressor is electrically powered and controlled by an electric switch mounted to the motorcycle within reach of a rider, so that the air pressure within the air spring can be adjusted while the motorcycle is being operated. Additionally, the air release valve preferably includes an electric solenoid for controlling the valve wherein a second electric switch is mounted to the motorcycle for operating the solenoid. The solenoid switch is also mounted to the motorcycle within reach of a rider thereof. Thus, by operation of the compressor and solenoid switches the rider of the motorcycle can either increase or decrease the air pressure in the air spring and control the elevation and cushioning effect of the seat.

In another aspect, the present invention provides a kit for modifying an existing motorcycle to include a pneumatic seating system according to the present invention. The kit includes a pivotable mount for pivotably attaching a first end portion of the motorcycle seat to the frame of the motorcycle and an air spring attachable at one end to a second end portion of the motorcycle seat and at a second end to the frame of the motorcycle.

The air spring defining an opening for receiving and expelling air from the air spring such that the air spring is adjustable between inflated and deflated positions. The inflated position wherein a length of the air spring is extended so that the second end portion of the motorcycle seat is spaced from the frame, the deflated position wherein the air spring the length of the air spring is in a retracted position such that the second end portion of the seat is substantially adjacent and supported by the frame.

The kit also includes an electric air compressor mountable to the frame of the motorcycle. An air release valve including an electric solenoid for operating the valve is included in the kit for releasing compressed air from the air spring.

The kit further includes mounting brackets for mounting the second end of the air spring, the air compressor and the air release valve to the frame of the motorcycle.

A preferred embodiment of the kit provides all materials to install the system of the present invention on an existing motorcycle along with instructions for the installation and operation of the system.

### BRIEF DESCRIPTION OF THE DRAWINGS

FIG. 1 is a partial side view of a motorcycle having an air spring in accordance with the present invention mounted between the seat and frame of the motorcycle. The air spring is shown in a deflated position.

FIG. 2 is a partial side view of the motorcycle of FIG. 1 showing the air spring in an inflated position.

FIG. 3 is a partially sectional, end view of a motorcycle having a pneumatic seating system in accordance with the present invention. The air spring is shown in a deflated position.

FIG. 4 shows the motorcycle of FIG. 3 with the air spring in an inflated position.

FIG. 5 shows one embodiment of a pair of air springs and spacer therefor in accordance with the present invention seating system.

### DETAILED DESCRIPTION OF THE INVENTION

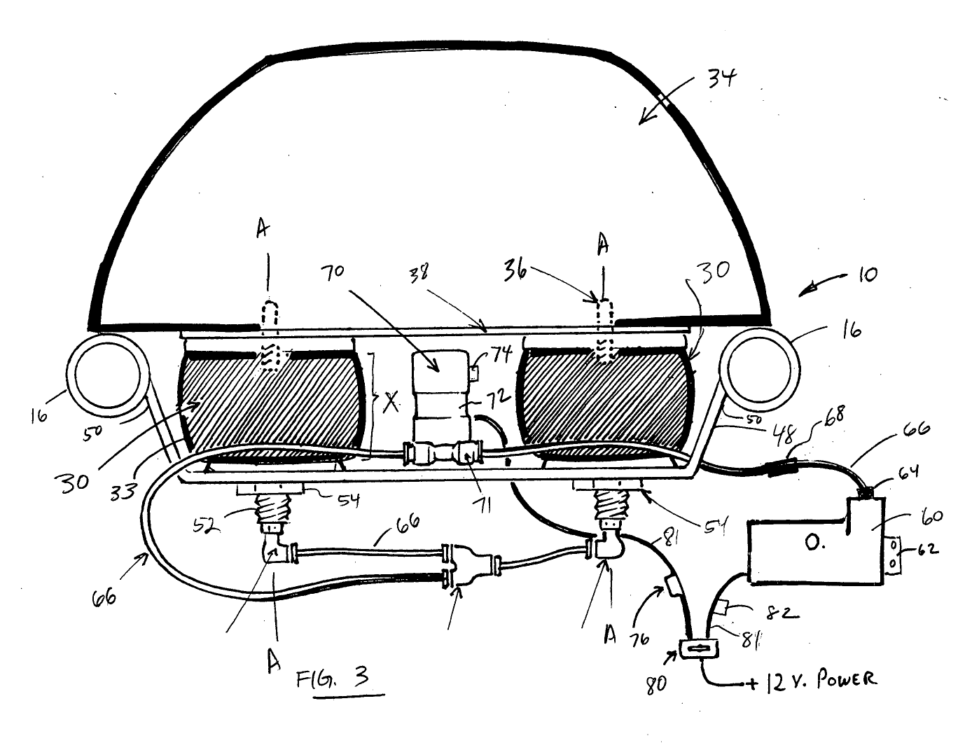

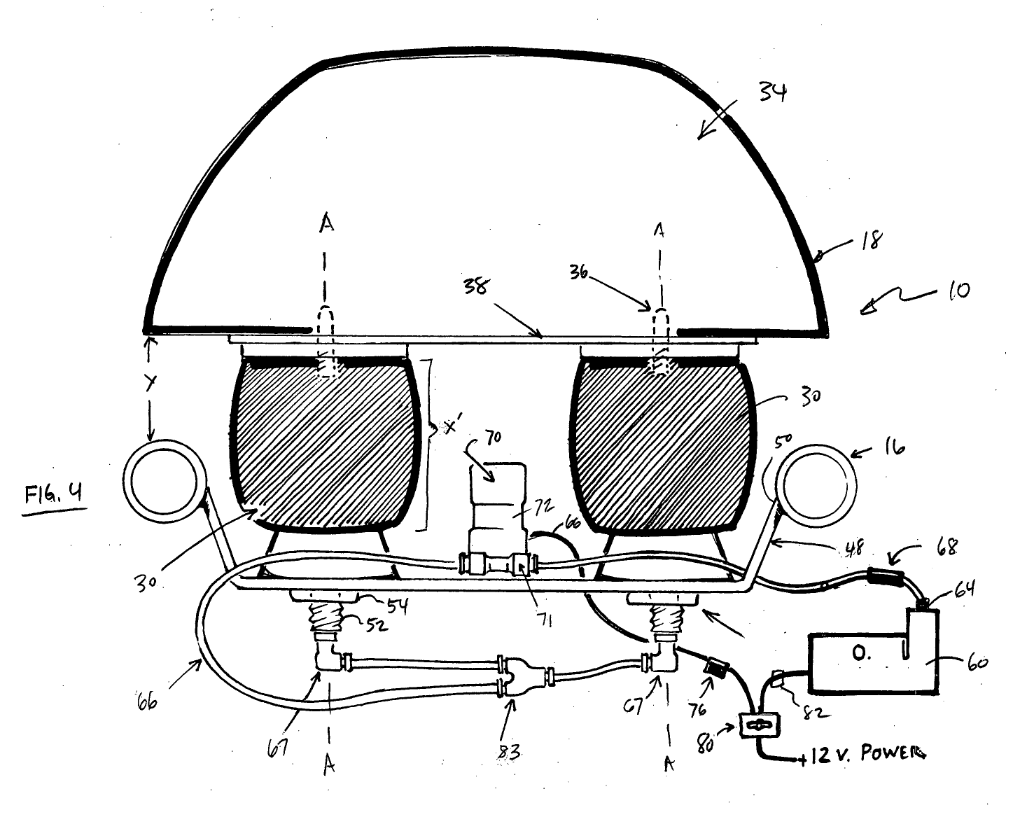

As shown in FIGS. 3-4, the present invention is directed to a pneumatic seating system generally designated by the reference number 10 for use with a motorcycle. The seating system 10 is typically used on a rigid frame motorcycle 12 wherein the motorcycle does not have a suspension system between a rear wheel 14 and a frame 16 of the motorcycle.

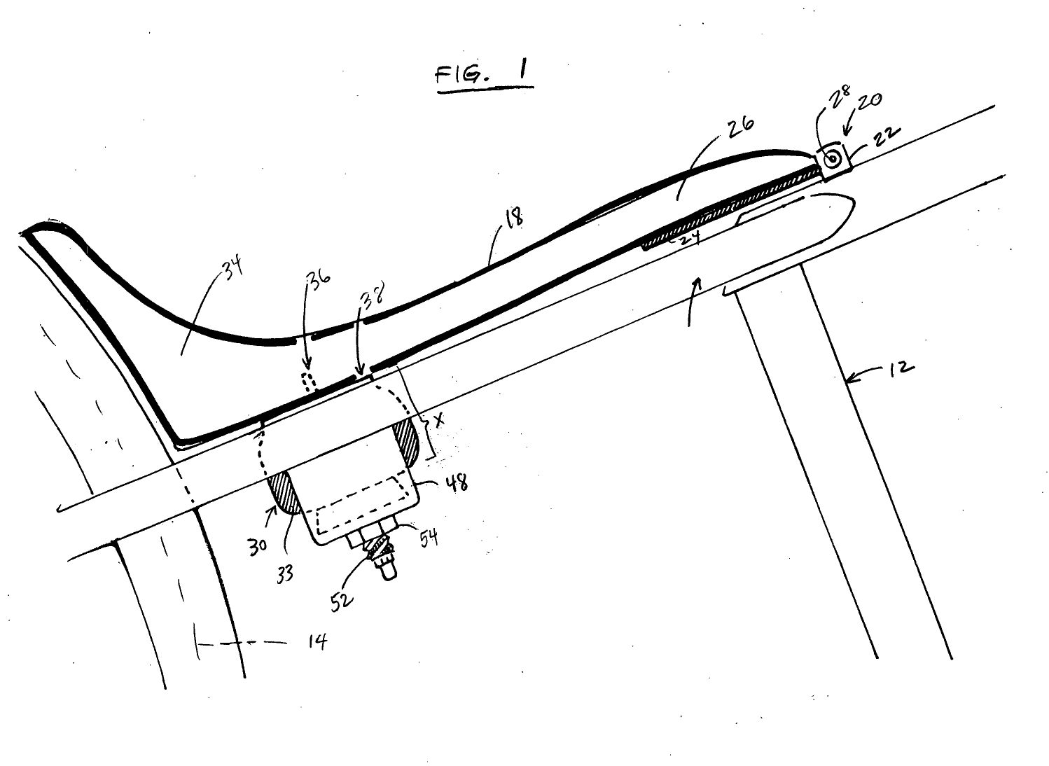

Referring to FIG. 1, the motorcycle 12 embodying the present invention seating system 10 includes a seat 18 pivotally mounted to the frame 16 via a pivotable mounting bracket 20. The pivotable mounting bracket 20 includes a frame portion 22 attached to the frame 16 and a seat portion 24 attached to the underside of an end portion 26 of the seat 18. A pivot pin 28 is disposed in corresponding holes in the frame portion 22 and the seat portion 24 and retained therein for pivotably mounting the seat 18 to the frame 16. Alternatively, other methods can be used for pivotably mounting an end portion 26 of the seat 18 to the frame 16 without departing from the scope of the invention.

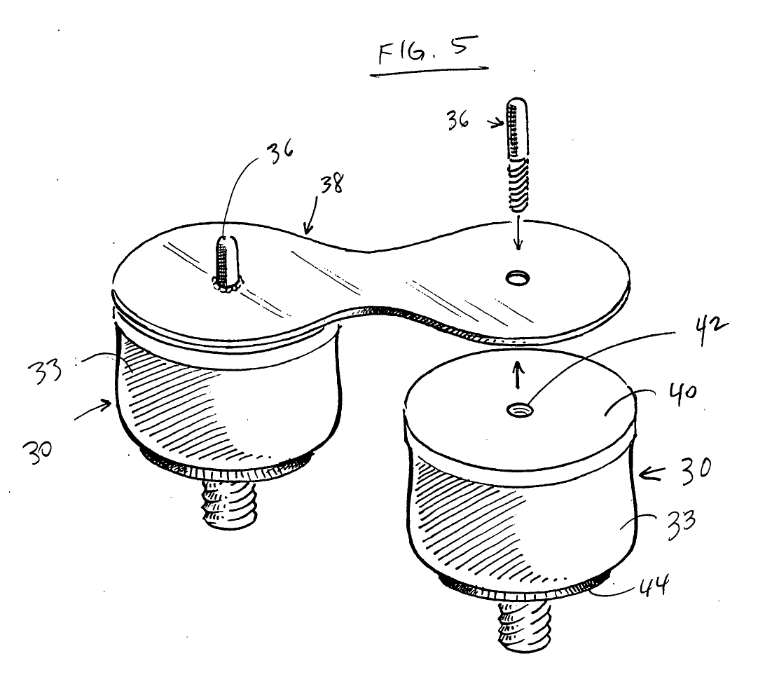

Referring to FIG. 3, the seating system 10 includes a pair of air springs 30, 30 shown mounted to a rear end portion 34 of the seat 18 via a pair of threaded studs 36, 36. The air springs 30, 30 each include a flexible housing 33 which defines a cavity (not shown) for retaining compressed air. A spacer 38 is mounted between the seat 18 and the air springs 30, 30 for positioning the air springs relative to the seat 18 and retaining a minimum space therebetween. The air springs 30, 30 and spacer 38 are best shown in FIG. 5. The threaded studs 36, 36 are press fit into corresponding openings in the underside of the rear end portion 34 of the seat 18 for securing the studs to the seat. As shown, in FIG. 5, a first end 40 of each of the air springs 30, 30 defines a threaded hole 42 for attaching the air springs 30 to one of the threaded studs 36 and the seat 18. A second end 44 of each of the air springs 30, 30 attaches to the frame 16 of the motorcycle as discussed further hereinbelow.

Still referring to FIG. 3, the air springs 30, 30 are mounted to a mounting bracket 48 that is attached to the frame 16. In the FIG. 3 embodiment, the mounting bracket 48 is welded to the frame 16 at opposing ends 50 thereof. The second end 44 of each of the air springs 30 is mounted via a threaded port 52 and nut 54 to openings in the mounting bracket 48 such that the air springs 30, 30 are secured between the mounting bracket 48 and the rear end portion 34 of the seat 18. The port 52 is in communication with the cavity interior of the flexible housing 33 of the air springs 30, 30 for receiving and expelling pressurized air therefrom. The air springs 30, 30 being adjustable between inflated and deflated positions.

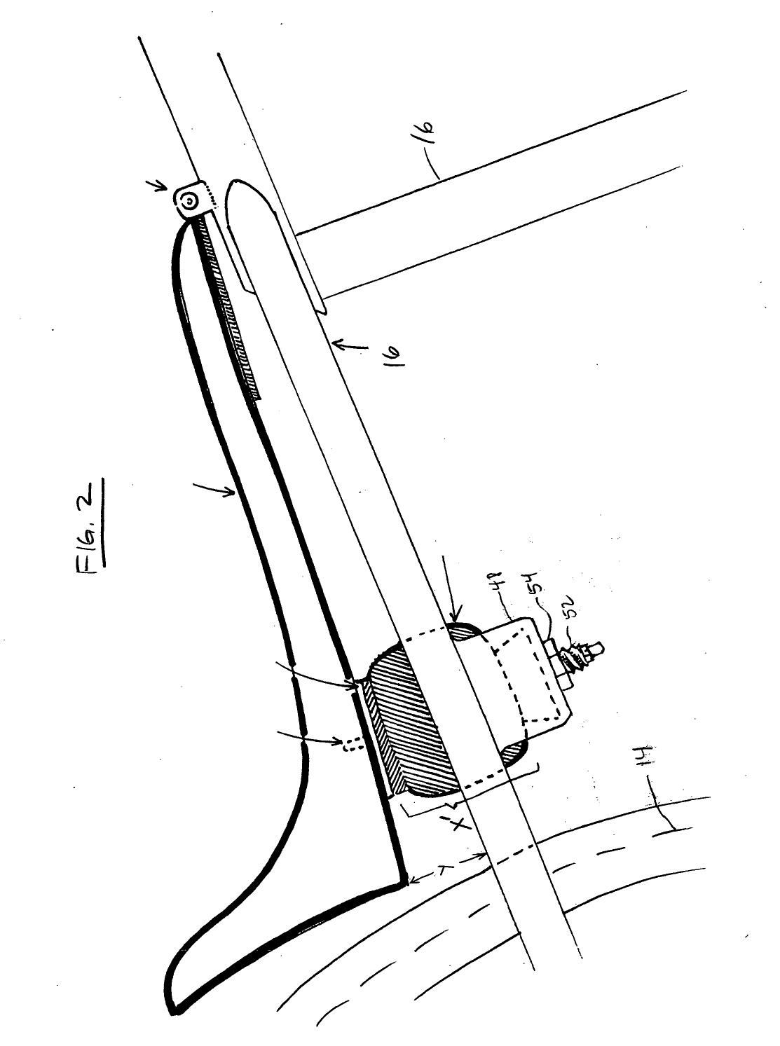

In the deflated position a length x of the flexible housing 33 of the air springs 30, 30 is in a retracted or normal position such that the rear end portion 34 of the seat is substantially adjacent and supported by the frame 16 as shown in FIGS. 1 and 3. When the air springs 30, 30 are in the inflated position, the length of the flexible housing 33 is extended to a length x′ wherein the rear end portion 34 of the seat 18 is spaced a distance y from the frame as shown in FIGS. 2 and 4. The distance y between the seat 18 and the frame 16 when the air springs 30, 30 are inflated along with the compressibility of the flexible housing 33 and the air therein allow the seat 18 to move in a direction generally along an axis A-A of the air springs 30, 30. The compressibility of the air springs 30, 30 provide a cushioning effect for a rider seated on the seat 18 of the motorcycle when the motorcycle is in use especially when driven over rough terrain such as bumps or holes in a roadway.

As shown in FIGS. 3 and 4, the seating system 10 includes an air compressor 60 which is mountable to the frame 16 of the motorcycle 12 via a compressor bracket 62. The air compressor 60 shown in FIGS. 3 and 4 is not mounted to the motorcycle 12, however, one skilled in the art will understand that the bracket 62 is used with a corresponding clamp or another bracket or fasteners for mounting the air compressor to the frame 16 of the motorcycle 12 or an attachment thereto. Typically, the air compressor 60 is mounted to the frame 16 of a motorcycle below the seat 18.

The air compressor 60 includes an outlet 64 coupled via air lines 66 and fittings 67 to the ports 52 of the air springs 30, 30. In the FIG. 3 embodiment, a one-way valve or check valve 68 is installed in the air line 66 between the outlet 64 of the compressor and the ports 52 of the air springs 30, 30 to retain the compressed air in the air springs 30, 30 and prevent the compressed air from leaking out of the air springs back toward the air compressor.

An air release valve 70 is coupled to the air lines 66 between the check valve 68 and the air springs as shown in FIG. 3. The air release valve 70 includes an electric solenoid 72 for electrically operating the air release valve and an outlet 74 which is open ended and used for expelling air from the air springs 30, 30 via the air lines 66 when the air release valve is in an open position. The electric solenoid 72 operates the air release valve 70 between open and closed positions via a solenoid switch 76 which is coupled between the solenoid 72 and a power supply 80 of the motorcycle 12. Typically, the solenoid switch 76 is a moment switch which is an electrical switch which controls the solenoid to open the air release valve 70 and allow air to be released from the air springs 30, 30 only while the switch is depressed.

In the FIG. 3 embodiment, the air release valve 70 is shown coupled to the air line 66 between the ports 52 of the air springs 30, 30 and the check valve 68. A “T” fitting 71 is used to couple the air release valve 70 to the air line 66 on a pressure side of the check valve 68 between the check valve and the ports 52 to the air springs 30, 30. Alternatively, the air release valve 70 could be coupled directly to one of the ports 52 or anywhere on the pressure side of the check valve 68.

The FIG. 3 embodiment includes a Y-fitting 83 for branching the air line 66 from the compressor 60 so that it can be coupled to each of the air springs 30, 30. In other embodiments of the seating system of the present invention, only one air spring may be utilized.

Still referring to FIG. 3, the air compressor 60 is electrically powered and wired to the power supply 80 of the motorcycle 12 via electrical wires 81. An electrical switch 84 controls the operation of the air compressor 60. Typically, the electric switch 84 is a moment switch so that the air compressor 60 is turned on only when the switch 84 is operated. In the preferred embodiment, a two-way momentary toggle or rocker switch is utilized for both the electric switch 84 for controlling the air compressor 60 and the solenoid switch 76 for controlling the air release valve 70. Thus, operation of a single switch controls both increasing or releasing the air pressure in the air springs 30, 30 which effects the height, cushioning and comfort level of the seat 18. As will be readily apparent to one skilled in the art, the seating system of the present invention allows a rider to adjust the air pressure in the air springs 30, 30 by controlling the switches for the air compressor 60 and/or the air release valve 70 while operating the motorcycle 12.

Referring to FIG. 4, the seating system 10 of the present invention is shown with the air springs 30, 30 in an inflated position such that the air springs are extended to a length x′ and the rear end portion 34 of the seat 18 is raised off of the frame 16 a distance y and supported by the air springs. Depending on the specifications of the air springs 30, 30, the weight of the rider and the desired comfort level, the rider of the motorcycle can increase or decrease the air pressure in the air springs 30, 30 while operating the motorcycle via the electrical switch 82 and solenoid switch 76 as discussed above.

In another aspect of the present invention, a kit is provided for modifying an existing motorcycle to include the pneumatic seating system 10. The kit includes a pivotal mount 20 for pivotally mounting an end portion of the seat to the frame 16 of a motorcycle 12, at least one air spring 30 and mounting bracket 48 therefor, an electrically operated air release valve 70, a check valve 68, and an electrically powered air compressor 60. Various mounting brackets for mounting the air compressor 60, the air release valve 70, and the check valve 68 are also included in the kit. Additionally, the kit includes the air lines 66 and fittings therefor, the electric switches 76 and 82 and appropriate wiring, fuses, and electrical connectors for connecting the air compressor 60 and electrically operated air release valve 70 to the power supply of a motorcycle. Further, the kit includes installation and operating instructions for the pneumatic seating system 10. A motorcycle modified with the kit of the present invention operates the same as the motorcycle 12 described hereinabove.

The mounting bracket 48 shown in FIGS. 3 and 4 for mounting the air springs 30, 30 and air release valve 70 to the frame 16 is designed to be welded to the frame 16 at the opposing ends 50 of the bracket. Alternatively, a mounting bracket (not shown) is provided for mounting the air springs 30, 30 and air release valve 70 to the frame 16 of a motorcycle that clamps to the frame 16.

Referring again to FIG. 3, in one embodiment of the present invention, the mounting bracket 48 is configured so that the air springs 30, 30 are positioned below the seat 18 and interior the frame 16 of the motorcycle such that when the air springs are in the deflated position, the seat is substantially adjacent to and supported by the frame. As shown in FIG. 3, the mounting bracket 48 is generally U-shaped wherein the air springs 30, 30 are mounted inside the U and thus substantially hidden from view when in the deflated position. Accordingly, the U-shaped mounting bracket 48 substantially conceals the air springs 30, 30 from view when the air springs are in the deflated position. This is advantageous as it provides a cleaner overall appearance for the motorcycle 12. Additionally, the motorcycle has the appearance of a truly rigid frame motorcycle wherein there is no suspension between the seat and the frame nor the frame and the roadway or street.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

1. An pneumatic seating system for use with a motorcycle comprising:
means for pivotally mounting a first end portion of a motorcycle seat to the frame of the motorcycle;
an air spring mountable between a second end portion of the motorcycle seat and the frame, the air spring having a flexible housing defining a cavity for retaining pressurized air, the air spring further defining an opening in fluid communication with the cavity for receiving and expelling pressurized air from the cavity, the air spring being adjustable between inflated and deflated positions, the inflated position wherein pressurized air is retained in the cavity such that a length of the air spring is extended so that the second end portion of the seat is spaced apart from the frame, the deflated position wherein the air spring is in a retracted position;
an air compressor mountable to the frame and having an outlet coupled to the opening of the air spring for pressurizing the air spring;
an air release valve coupled to the opening of the air spring for releasing pressurized air from the air spring;
the air spring providing adjustable cushioning between the seat and the frame of the motorcycle for improving the comfort of a rider on the motorcycle.

2. The pneumatic seating system according to claim 1 wherein the air compressor is electrically powered, the system further comprising a first electric switch mounted to the motorcycle and connected to the air compressor such that activation of the first electric switch operates the air compressor for inflating the air spring.

3. The pneumatic seating system according to claim 1 wherein the air release valve further comprises an electric solenoid for controlling the air release valve.

4. The pneumatic seating system according to claim 3 further comprising a second electric switch connected to the electric solenoid such that activation of the second electric switch operates the air release valve for deflating the air spring.

5. The pneumatic seating system according to claim 2 wherein the first electric switch is a moment switch.

6. The pneumatic seating system according to claim 4 wherein the second electric switch is a moment switch.

7. The pneumatic seating system according to claim 1 wherein the adjustable air spring further comprises first and second adjustable air springs each being coupled to the air compressor and the air release valve such that that air pressure in the first air spring remains equal to the air pressure in the second air spring.

8. The pneumatic seating system according to claim 1 further comprising a mounting bracket for mounting the air spring to the frame of the motorcycle so that in the deflated position the air spring is substantially concealed beneath the seat.

9. The pneumatic seating system according to claim 2 wherein the air spring is automatically inflatable via the first electric switch for adjusting the cushioning between the seat and the frame while the motorcycle is in use and moving along a roadway.

10. The pneumatic seating system according to claim 4 wherein the air spring is automatically deflatable via the second electric switch for adjusting the cushioning between the seat and the frame while the motorcycle is in use and moving along a roadway.

11. A kit for mounting a pneumatic seating system to a motorcycle for automatically adjusting the cushioning of the seat of the motorcycle, the kit comprising:
a pivotable mount for pivotably attaching a first end portion of the motorcycle seat to the frame of the motorcycle;
an air spring attachable at one end to a second end portion of the motorcycle seat and at a second end to the frame of the motorcycle, the air spring defining an opening for receiving and expelling air from the air spring, the air spring being adjustable between inflated and deflated positions, the inflated position wherein a length of the air spring is extended such that the second end portion of the motorcycle seat is spaced from the frame, the deflated position wherein the air spring the length of the air spring is in a retracted position such that the second end portion of the seat is substantially adjacent and supported by the frame;
an electric air compressor mountable to the frame;
an air release valve including an electric solenoid for operating the valve;
mounting brackets for mounting at least one of, the second end of the air spring, the air compressor and the air release valve to the frame of the motorcycle;
wherein the kit is adapted to modify an existing motorcycle for automating the positioning of the seat relative to the frame and provide adjustable cushioning therebetween.

12. The kit according to claim 11 further comprising at least one electric switch mountable to the motorcycle and connectable to the air compressor and the air release valve for controlling the inflation of the air spring.

13. The kit according to claim 12 further comprising electrical wiring and connectors for connecting the electric switch to at least one of the air compressor, and the air release valve.

14. The kit according to claim 11 further comprising air hoses and fittings for coupling the inlet of the air spring to at least one of the outlet of the air compressor and the air release valve.

15. The kit according to claim 12 wherein the at least one electric switch includes a two-way moment switch.
